(19) United States
(12) Patent Application Publication
(10) Pub. No.: US 2026/0266423 A1
(43) Pub. Date: Sep. 10, 2026

(54) Magnetic electronic device stand

(71) Applicant: Shenzhen DeOne Innovation Technology Co., ltd, Shenzhen (CN)

(72) Inventor: Jianle Li, Quanzhou (CN)

(21) Appl. No.: 19/069,699

(22) Filed: Mar. 4, 2025

(51) Int. Cl. F16M 13/02; F16M 11/10

(52) U.S. Cl. CPC F16M 13/022; F16M 11/10

(57) ABSTRACT

Disclosed is a magnetic electronic device stand, comprising a support module and a fixation module. The support module is provided with an adsorption part, and the adsorption part is provided for adsorbing an electronic device. The fixation module comprises a fixation part and a rotating part. One end of the rotating part is hinged to one end of the support module through a first rotating shaft, and a second rotating shaft is provided at the other end of the rotating part. The rotating part is hinged to one end of the fixation part through the second rotating shaft. When the center line of the second rotating shaft is projected onto the plane where the center line of the first rotating shaft is located, the projection of the center line of the second rotating shaft is perpendicular to the center line of the first rotating shaft.

### CROSS REFERENCE TO RELATED APPLICATION

This application claims priority to Chinese Patent Application No. 202420734751.5, filed on Apr. 10, 2024, which is hereby incorporated by reference in its entirety.

### TECHNICAL FIELD

The present disclosure relates to the technical field of electronic device stands, and particularly relates to a magnetic electronic device stand.

### BACKGROUND

A long-distance journey can last for from a few hours to dozens of hours, during which a traveler, whether by plane, high-speed train, or bus, is often fatigable and bored. Watching movies on electronic devices can kill time and even handle some business affairs. However, prolong use of the electronic devices with the head lowered can put strain on cervical vertebrae, resulting in neck soreness. When holding the electronic devices at an eye level for an extended period of time will cause arm soreness, affecting overall comfort of the journey.

Existing electronic device stands on the market usually comprise a clamping portion for fixing the entire stand to a clamping object, and a rotating mechanism is arranged between the clamping portion and a device placement portion to allow the stand to be unfolded or stored for easy portability. However, the above stands often have a limited number of rotating structures, affecting the adaptability of the stands to various angles for different usage scenarios. In addition, the device placement portion usually uses a clamping mechanism to fix the electronic device, which is cumbersome to operate, and long-term clamping will cause deformation and damage to an outer shell of the electronic device.

### SUMMARY

In view of defects in the prior art, an objective of the present disclosure is to provide a magnetic electronic device stand. By arranging an adsorption portion to adsorb the electronic device, the present disclosure enables quick attachment of the electronic device to the stand or detachment of the electronic device from the stand.

In order to realize the above the objective, the present disclosure provides the following technical solution: a magnetic electronic device stand, which comprises a support module, an adsorption part and a fixation module. The adsorption part is provided on the support module, and the adsorption part is provided for adsorbing the electronic device. The fixation module comprises a fixation part, a rotating part and a clamping part. One end of the rotating part is hinged to one end of the support module through a first rotating shaft, and a second rotating shaft is provided at the other end of the rotating part. The second rotating shaft extends towards the fixation part, and the rotating part is hinged to one end of the fixation part through the second rotating shaft. The clamping part is provided for assembling the magnetic electronic device stand on the clamped object. When the center line of the second rotating shaft is projected onto the plane where the center line of the first rotating shaft is located, the projection of the center line of the second rotating shaft is perpendicular to the center line of the first rotating shaft. A fixation component is arranged between the adsorption part and the support module, and the adsorption part is fixedly assembled on the support module through the fixation component.

Preferably, the fixation component comprises an embedding unit and a matching unit. The embedding unit is arranged on the adsorption part, the matching unit is arranged on the support module, and the embedding unit is provided for inserting into the matching unit to assemble the adsorption part on the support module.

Preferably, the embedding unit comprises an embedding frame, a screw, and a positioning plate. The embedding frame is arranged on the adsorption part and on the surface of the adsorption part close to the support module. The head part of the screw is arranged within the range of the embedding frame, and the rod part of the screw extends towards the support module. The positioning plate is arranged on the outer edge of the embedding frame; The matching unit comprises a embedded slot, a screw hole, and a positioning slot. The embedded slot is arranged on the surface of the support module close to the adsorption part, and the embedded slot is provided for the embedding frame to embed, so as to assemble the adsorption part. The screw hole is arranged in the embedded slot, and the screw hole is provided for the screw to insert. The positioning slot is arranged on the outer edge of the embedded slot. When the embedding frame is embedded in the embedded slot, the positioning plate is inserted into the positioning slot.

Preferably, the positioning slot is communicated with the embedded slot, and the positioning plate is connected with the embedding frame.

Preferably, the positioning slot is arranged at an interval from the embedded slot, and the positioning plate is arranged at an interval from the embedding frame.

Preferably, a magnetic block is arranged on the adsorption part, or a suction cup is arranged on the adsorption part.

Preferably, the magnetic electronic device stand further comprises a reset unit, and the reset unit is connected with the fixation part. The clamping part comprise a first limiting unit, and a second limiting unit. The first limiting unit is arranged at one end of the fixation part away from the first rotating shaft and extends in the direction away from the first rotating shaft. The second limiting unit is movably connected with the reset unit, so that the second limiting unit is slidably connected with the fixation part and is located at one end of the fixation part away from the first rotating shaft. At least a part of the second limiting unit can move near to or away from at least a part of the first limiting unit to form a clamping space. With the movement of the second limiting unit, the size of the clamping space can be adjusted. The reset unit is provided for pushing the second limiting unit towards the first limiting unit, so that the second limiting unit can move near to the first limiting unit.

Preferably, the first limiting unit comprises a first connecting part and a first limiting part, The first connecting part is arranged at one end of the fixation part away from the first rotating shaft and extends in the direction away from the first rotating shaft. The first limiting part is arranged on the first connecting part and away from the fixation part, and the first limiting part is perpendicular to the first connecting part; The second limiting unit comprises a second connecting part, and a second limiting part. One end of second connecting part is connected with the reset unit. The second limiting part is arranged at one end of the second connecting part away from the fixation part, and the second limiting part is perpendicular to the second connecting part. The second limiting part can movably move away from or move near to the first limiting part. When the second limiting part moves away from the first limiting part, an interval between the second limiting part and the first limiting part form the clamping space.

Preferably, the reset unit comprises a third connecting part and a reset part, one end of the third connecting part is fixedly connected with the fixation part, and the other end of the third connecting part is movably connected with the second connecting part. The reset part is clamped between the second connecting part and the fixation part.

Preferably, a hand-operated part is arranged on the second limiting part, and the hand-operated part is provided for a user to pull the second limiting part to move away from the first limiting part.

Preferably, the hand-operated part is a L-shaped plate, and one end of the hand-operated part is fixedly connected with the second limiting part.

The above technical solution of the present disclosure has the following beneficial effects: a magnetic electronic device stand comprises a support module and a fixation module. The support module is provided with an adsorption part, and the adsorption part is provided for adsorbing an electronic device. The fixation module comprises a fixation part and a rotating part. One end of the rotating part is hinged to one end of the support module through a first rotating shaft, and a second rotating shaft is provided at the other end of the rotating part. The rotating part is hinged to one end of the fixation part through the second rotating shaft. The fixation module is provided with a clamping part, which is provided for assembling the magnetic electronic device stand on a clamped object. When the center line of the second rotating shaft is projected onto the plane where the center line of the first rotating shaft is located, the projection of the center line of the second rotating shaft is perpendicular to the center line of the first rotating shaft. A fixation component is arranged between the adsorption part and the support module, and the adsorption part is fixedly assembled on the support module through the fixation component. By setting the adsorption part, the magnetic electronic device stand can adsorb the electronic device, thus simplifying the way to fix the electronic device.

### BRIEF DESCRIPTION OF THE DRAWINGS

In order to more clearly illustrate the technical solution in embodiments of the present disclosure or in the prior art, a brief introduction to the accompanying drawings required for the description of the embodiments or the prior art will be provided below. Obviously, the accompanying drawings in the following description are merely some embodiments of the present disclosure. Those of ordinary skill in the art would also derive other accompanying drawings from these accompanying drawings without making inventive efforts.

FIG. 1 is a structural schematic diagram according to the present disclosure.

FIG. 2 is an exploded view corresponding to FIG. 1.

FIG. 3 is a structural schematic diagram of the fixation module according to the present disclosure.

FIG. 4 is another state schematic diagram according to the present disclosure.

FIG. 5 is a structural schematic diagram of the support module according to the present disclosure.

FIG. 6 is a sectional view in the direction of A-A′ corresponding to FIG. 1.

### REFERENCE NUMERALS IN THE ACCOMPANYING DRAWINGS

10. support module; 11. adsorption part; 20. fixation module; 21. fixation part; 211. main body; 2111. first shaft groove; 212. front cover; 2121. second shaft groove; 213. damping sleeve; 22. rotating part; 221. shaft hole; 23. clamping part; 231. first limiting unit; 2311. first connecting part; 2312. first limiting part; 23121. first protective pad; 232. second limiting unit; 2321. second connecting part; 23211. guide hole; 23212. limiting block; 2322. second limiting part; 23221. second protective pad; 2323. hand-operated part; 30. first rotating shaft; 40. second rotating shaft; 51. embedding unit; 511. embedding frame; 512. screw; 513. positioning plate; 52. matching unit; 521. embedded slot; 522. screw hole; 523. positioning slot; 60. reset unit; 61. third connecting part; 62. reset part; 70. clamping space.

### DETAILED DESCRIPTIONS OF THE EMBODIMENTS

The present disclosure will be further described in conjunction with the accompanying drawings and the embodiments.

The specific embodiments are merely the explanation of, rather than limitations on, the present disclosure. After reading the specification, those skilled in the art may make modifications to the embodiments without any inventive contributions as needed, however, as long as these modifications fall within the scope of the claims of the present disclosure, they are protected by the patent law.

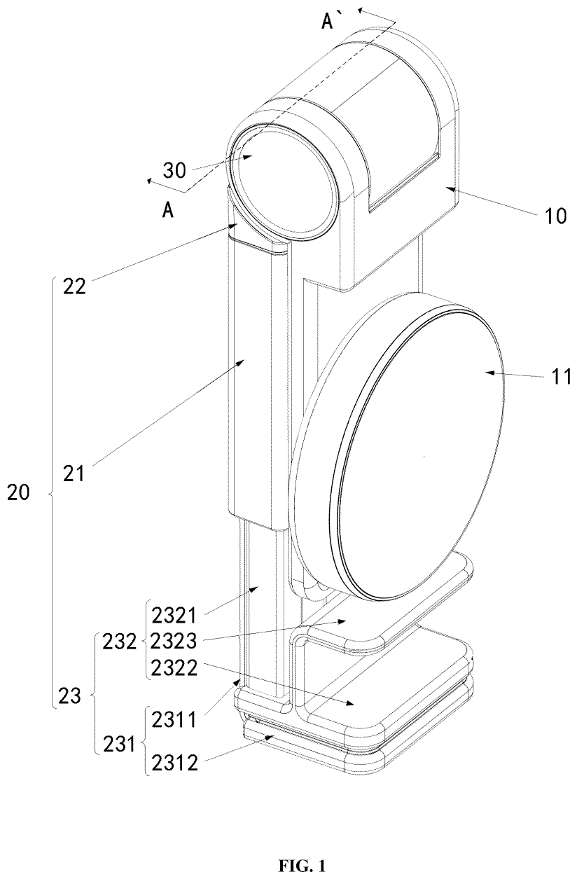

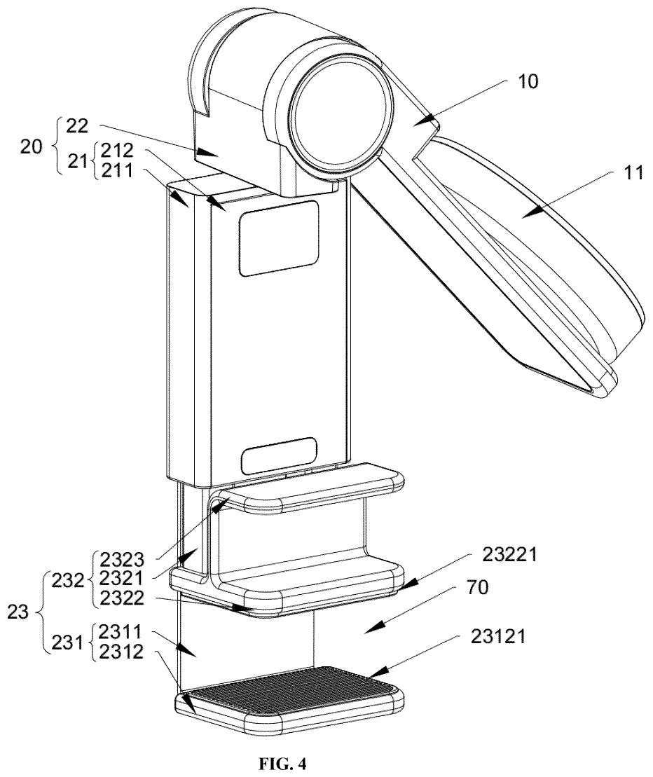

This embodiment relates to a magnetic electronic device stand, which is used to fixedly connect an electronic device with a clamped object. As shown in FIGS. 1-4, the device comprises a fixation module 20 and a support module 10.

The fixation module 20 comprises a fixation part 21, a rotating part 22 and a clamping part 23. One end of the rotating part 22 is hinged to one end of the support module 10 through a first rotating shaft 30, that is, the fixation module 20 is hinged to the support module 10 through the first rotating shaft 30. The first rotating shaft 30 allows the fixation module 20 and the support module 10 to rotate relative to each other. By rotating the fixation module 20 and the support module 10 and setting them at an angle, the two can be folded or unfolded.

The other end of the rotating part 22 is provided with a second rotating shaft 40, and the second rotating shaft 40 extends towards the fixation part 21. One end of the rotating part 22 and One end of the fixation part 21 are hinged through the second rotating shaft 40, and the second rotating shaft 40 is provided for the rotating connection between the fixation part 21 and the rotating part 22. Wherein, when the central line of the second rotating shaft 40 is projected onto the plane where the central line of the first rotating shaft 30 is located, the projection of the central line of the second rotating shaft 40 is perpendicular to the central line of the first rotating shaft 30. After the fixation module 20 and the support module 10 are unfolded, the second rotating shaft 40 can be used for the support module 10 to rotate in the vertical direction relative to the fixation module 20.

The clamping part 23 is provided for assembling the magnetic electronic device stand on the clamped object. Preferably, the clamping part 23 is arranged at one end of the fixation part 21 away from the rotating part 22 to reduce the obstruction between the fixation part 21 and the rotating part 22 when they rotate relative to each other. At the same time, it is beneficial to reduce the size of the fixation part 21 in the direction from the rotating part 22 to the fixation part 21, which is beneficial to the miniaturization of the magnetic electronic device stand for easy carrying.

The support module 10 is provided with an adsorption part 11. Specifically, the adsorption part 11 is an elliptical or cylindrical shell, and a plurality of magnets are arranged on the surface of the shell away from the support module 10. Therefore, when the user brings the electronic device close to the magnets on the adsorption part 11, the electronic device can be adsorbed on the adsorption part 11, so as to assemble the electronic device on the magnetic electronic device stand; at the same time, the user can arbitrarily adjust the orientation of the electronic device on the adsorption part 11, so that the electronic device can be rotatably assembled on the adsorption part 11. By adjusting the rotation of the two rotating shafts and the arbitrary orientation of the adsorption part 11, the entire magnetic electronic device stand can be flexibly adapted to a variety of usage scenarios.

In other embodiments, a plywood is arranged on the surface of the shell of the adsorption part 11 away from the support module 10, and the electronic device can be pasted on the plywood. Also, a suction cup can be set to adsorb the electronic device.

It should be noted that the adsorption part 11 can be used for fixedly placing the electronic device when the magnetic electronic device stand is in the unfolded or stored state. When the magnetic electronic device stand is in the stored state, the fixation module 20 and the support module 10 are folded and stored. At this time, the adsorption part 11 can still be used for fixedly placing the electronic device on it. The magnetic electronic device stand can be clamped on the clamped object through the clamping part 23. At this time, partially unfolding the support module 10 and the fixation module 20, the device can also be used. The space where the support module 10 and the fixation module 20 are partially unfolded can be used for the clamping part 23 to stretch out to clamp the clamped object, improving the convenience of use.

In this embodiment, the electronic device comprises but is not limited to: mobile phones, computers, tablets and video game consoles.

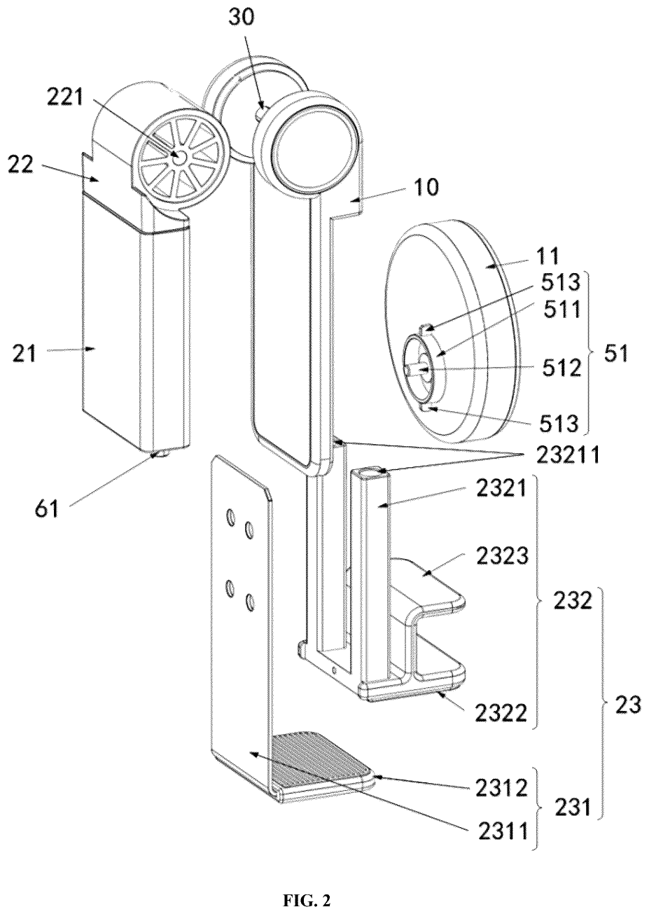

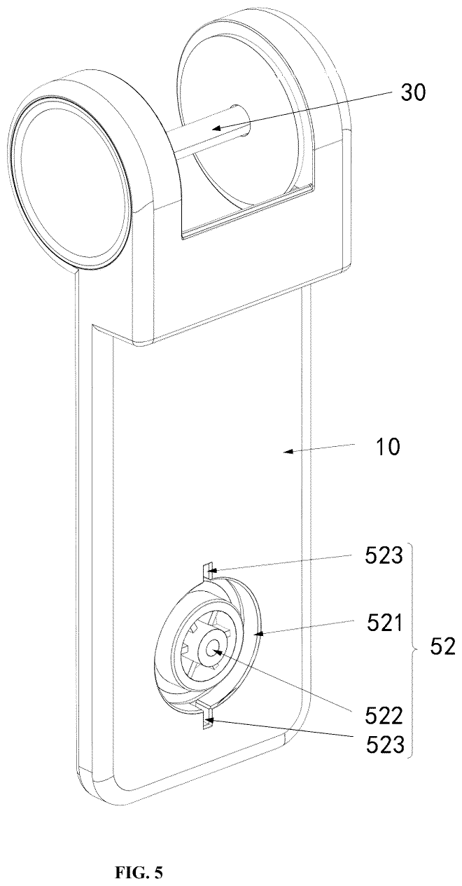

As shown in FIGS. 2 and 5, a fixation component is arranged between the adsorption part 11 and the support module 10. The adsorption part 11 is fixedly assembled on the support module 10 through the fixation component, and the assembled adsorption part 11 cannot rotate or move relative to the support module 10. The fixation component comprises an embedding unit 51 arranged on the adsorption part 11 and a matching unit 52 arranged on the support module 10. The embedding unit 51 is used to be inserted into the matching unit 52 to realize the fixed assembly of the adsorption part 11 on the support module 10. In other embodiments, a damping rotating shaft is arranged between the adsorption part 11 and the support module 10, and the damping rotating shaft can be used for the adsorption part 11 to rotate relative to the support module 10.

Preferably, the embedding unit 51 comprises an embedding frame 511, a screw 512 and a positioning plate 513. The embedding frame 511 is arranged on the surface of the adsorption part 11 close to the support module 10, and the embedding frame 511 is arranged in a circular ring shape; the head part of the screw 512 is arranged within the range of the embedding frame 511. Specifically, the horizontal central line of the head of the screw 512 coincides with the horizontal central line of the circular ring structure of the embedding frame 511; the rod part of the screw 512 is arranged towards the support module 10, and the positioning plate 513 is arranged on the outer edge of the embedding frame 511.

It should be added that the matching unit 51 comprises: an embedded slot 521, a screw hole 522 and a positioning slot 523. The embedded slot 521 is arranged on the surface of the support module 10 close to the adsorption part 11. The shape of the embedded slot 521 is adapted to the embedding frame 511, and the embedded slot 521 can be used for the embedding frame 511 to be inserted, so as to realize the assembly of the adsorption part 11; the positioning slot 523 is arranged on the outer edge of the embedded slot 521. When the embedding frame 511 is inserted into the embedded slot 521, the positioning plate 513 is inserted into the positioning slot 523 to realize the positioning of the adsorption part 11 on the support module 10, so that the adsorption part 11 cannot rotate relative to the support module 10; the screw hole 522 is arranged in the embedded slot 521, and the screw hole 522 can be used for the screw 512 to be inserted. After being inserted, the screw 512 can prevent the adsorption part 11 from falling off the support module 10. Specifically, the screw 512 is an expansion screw. In other embodiments, the screw can be replaced with a threadless pin.

In this embodiment, there have been arranged two positioning plates 513. The two positioning plates 513 are arranged oppositely on the outer edge of the embedding frame 511. In other embodiments, one, three, four or more positioning plates 513 can be arranged, and they can also be arranged on the inner edge of the embedding frame 511, or positioning plates 513 can be arranged on both the inner and outer edges of the embedding frame 511 at the same time.

It should be added that the positioning slot 523 is communicated with the embedded slot 521, and the positioning plate 513 is connected to the embedding frame 511. In other embodiments, the positioning slot 523 is not communicated with the embedded slot 521 and is arranged at intervals. The positioning plate 513 and the embedding frame 511 are two independent components, which are arranged at intervals and there is no connection relationship between them.

In this embodiment, a baffle for limiting the rotation range of the first rotating shaft 30 is arranged on the rotating part 22. The baffle is arranged in an arc shape and fits the part of the first rotating shaft 30 that is close to the second rotating shaft 40, so that when the support module 10 rotates through the first rotating shaft 30 and gradually unfolds, the path of the continuous rotation of the support module 10 will be blocked by the baffle, so that the rotation angle between the support module 10 and the fixation module 20 is limited within a certain range. Preferably, the angle range is 0-240°, and it can also be other ranges, such as 0-180° or 0-200°.

As shown in FIGS. 2-4 and 6, the magnetic electronic device stand also comprises a reset unit 60, and the reset unit 60 is connected to the fixation part 21. It should be added that the clamping part 23 comprises a first limiting unit 231 and a second limiting unit 232. The first limiting unit 231 is arranged at one end of the fixation part 32 away from the first rotating shaft 30 and extends in the direction away from the first rotating shaft 30. The second limiting unit 232 is movably connected to the reset unit 60, so that the second limiting unit 232 is slidably connected to the fixation part 21 and is located at one end of the fixation part 21 away from the first rotating shaft 30. At least a part of the second limiting unit 232 can move to close to or away from at least a part of the first limiting unit 231 to form a clamping space 70. With the movement of the second limiting unit 232, the size of the clamping space 70 can be adjusted.

It should be added that the reset unit 60 is used to push the second limiting unit 232 towards the first limiting unit 231, so that the second limiting unit 232 can move near to the first limiting unit 231.

Preferably, the first limiting unit 231 comprises a first connecting part 2311 and a first limiting part 2312. The first connecting part 2311 is arranged at one end of the fixation part 21 away from the first rotating shaft 30 and extends in the direction away from the first rotating shaft 30. The first limiting part 2312 is arranged on the first connecting part 2311 and is away from the fixation part 21. The first limiting part 2312 is arranged perpendicular to the first connecting part 2311.

It should be added that the second limiting unit 232 comprises a second connecting part 2321 and a second limiting part 2322. One end of the second connecting part 2321 is connected to the reset unit 60. The second limiting part 2322 is arranged at one end of the second connecting part 2321 away from the fixation part 21. The second limiting part 2322 is perpendicular to the second connecting part 2321. The second limiting part 2322 can move away from or close to the first limiting part 2312. When the second limiting part 2322 moves away from the first limiting part 2312, an interval between the second limiting part 2322 and the first limiting part 2312 forms a clamping space 70. The clamping space 70 is used to clamp the clamped object. The distance between the second limiting part 2322 and the first limiting part 2312 can be adjusted by sliding the second limiting part 2322, so that the size of the clamping space can be adjusted to adapt to clamped objects with different shapes and sizes.

In this embodiment, protective pads are arranged on both the surface of the second limiting part 2322 facing the first limiting part 2312 and the surface of the first limiting part 2312 facing the second limiting part 2322, to increase the clamping friction force on the clamped object.

It should be added that the first connecting part 2311 can be a plate-shaped structure, or a rod-shaped structure or a double-helical structure or a combination of them. The first limiting part 2312 can be a plate-shaped structure or a rod-shaped structure, wherein the rod-shaped structure can be composed of one or more rods. The second connecting part 2321 can be a plate-shaped structure, or a rod-shaped structure or a double-helical structure or a combination of them. The second limiting part 2322 can be a plate-shaped structure or a rod-shaped structure, wherein the rod-shaped structure can be composed of one or more rods. In this embodiment, the first connecting part 2311, the first limiting part 2312 and the second limiting part 2322 are all plate-shaped structures, and the second connecting part 2321 is a double-rod structure.

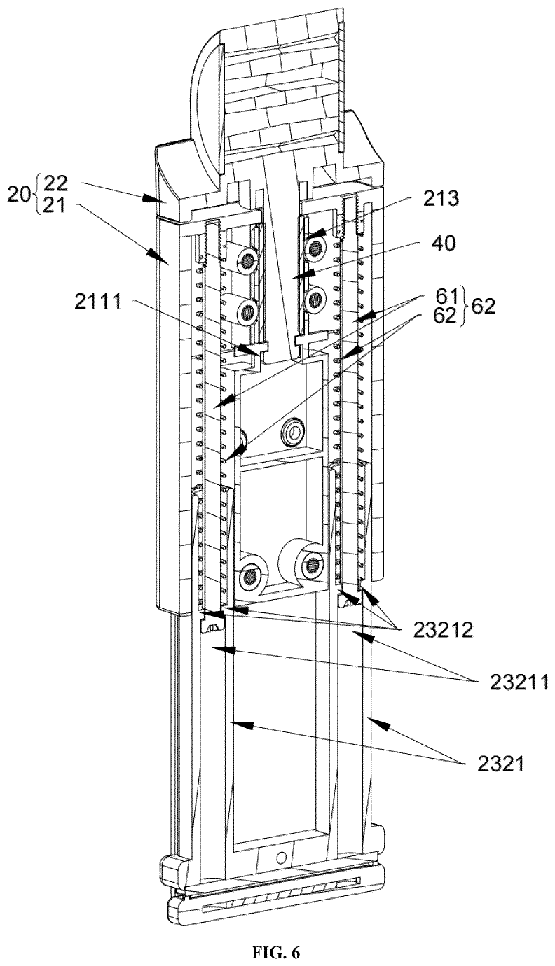

As shown in FIG. 6, the reset unit 60 comprises a third connecting part 61 and a reset part 62. One end of the third connecting part 61 is fixedly connected to the fixation part 21, and the other end of the third connecting part 61 is movably connected to the second connecting part 2321. The reset part 62 is clamped between the second connecting part 2321 and the fixation part 21. The reset part 62 is used to push the second limiting part 2322 towards the first limiting part 2312 when the second limiting part 2322 moves away from the first limiting part 2312.

In this embodiment, both the third connecting part 61 and the second connecting part 2321 are double-rod structures. The third connecting part 61 is composed of two screw rods, and the reset part 62 is a spring set composed of two springs. The reset part 62 is sleeved on the outside of the third connecting part 61. The second connecting part 2321 is provided with a guide hole 23211, and at least a part of the combination of the reset part 62 and the third connecting part 61 is inserted into the guide hole 23211. A limiting block 23212 protrudes from the hole wall of the guide hole 23211. The tail of the screw rod is fixedly connected to the fixation part 21, and the head part of the screw rod protrudes towards the hole wall of the guide hole 23211. The upper surface of the head part of the screw rod abuts against the lower surface of the limiting block 23212 to prevent the second connecting part 2321 from breaking away from the combination of the reset part 62 and the third connecting part 61. The upper surface of the limiting block 23212 abuts against one end of the reset part 62, and the other end of the reset part 62 abuts against the fixation part 21 to push the second connecting part 2321 towards the first limiting part 2312, so that the second limiting part 2322 can move near to the first limiting part 2312.

As shown in FIGS. 2-4 and 6, when the user pulls the second limiting part 2322, that is, when pulling the second limiting part 2322 to slide towards the fixation part 21, the reset part 62 is compressed in the guide hole 23211, thus generating a return pushing force of the second limiting part 2322 towards the first limiting part 2312, so that the first limiting part 2312 and the second limiting part 2322 can cooperate to effectively clamp the clamped object. After the clamping space 70 is enlarged and the clamped object is placed in the clamping space 70, when the user releases the hand pulling the second limiting part 2322, the reset part 60 resets, and the second connecting part 2321 can be pushed towards the first limiting part 2312, so that the second limiting part 2322 can move near to the first limiting part 2312, making the second limiting part 2322 and the first limiting part 2312 to clamp the clamped object. Thus, realizing the bottom of the entire magnetic electronic device stand to be fixed.

Specifically, when the support module 10 is partially unfolded relative to the fixation module 20, the second limiting part 2322 can slide towards the reset part 62, and the partial unfolded angle is not less than 15°.

In this embodiment, the first connecting part 2311 and the first limiting part 2312 are fixedly assembled, and they are arranged in an L-shaped sheet shape after being assembled. The second connecting part 2321 and the second limiting part 2322 are fixedly assembled, also they are in an L-shaped sheet shape after being assembled. The second connecting part 2321 is arranged parallel to the first connecting part 2311, and the second limiting part 2322 is arranged parallel to the first limiting part 2312.

In other embodiments, the first connecting part 2311 and the first limiting part 2312 are arranged in other shapes after being fixedly assembled, such as a V shape or an N shape. In other embodiments, the second limiting part 2322 is not parallel to the first limiting part 2312. For example, the second limiting part 2322 is an arch bridge shape with the middle arching towards the first limiting part 2312, and the first limiting part 2312 is an arch bridge shape with the middle arching towards the second limiting part 2322.

In this embodiment, a second protective pad 23221 is arranged on the surface of the second limiting part 2322 facing the first limiting part 2312, and a first protective pad 23121 is arranged on the surface of the first limiting part 2312 facing the second limiting part 2322. The first protective pad 23121 and the second protective pad 23221 are used to increase the friction force, specifically the friction force when the first limiting part 2312 and the second limiting part 2322 cooperate to clamp the clamped object.

Preferably, a hand-operated part 2323 is arranged on the second limiting part 2322. The hand-operated part 2323 is provided for the user to pull the second limiting part 2322 to move away from the first limiting part 2312.

Preferably, the hand-operated part 2323 is a L-shaped plate and one end of the hand-operated part 2323 is fixedly connected to the second limiting part 2322. The hand-operated part 2323 can facilitate the user to pull the second limiting part 2322 by hand.

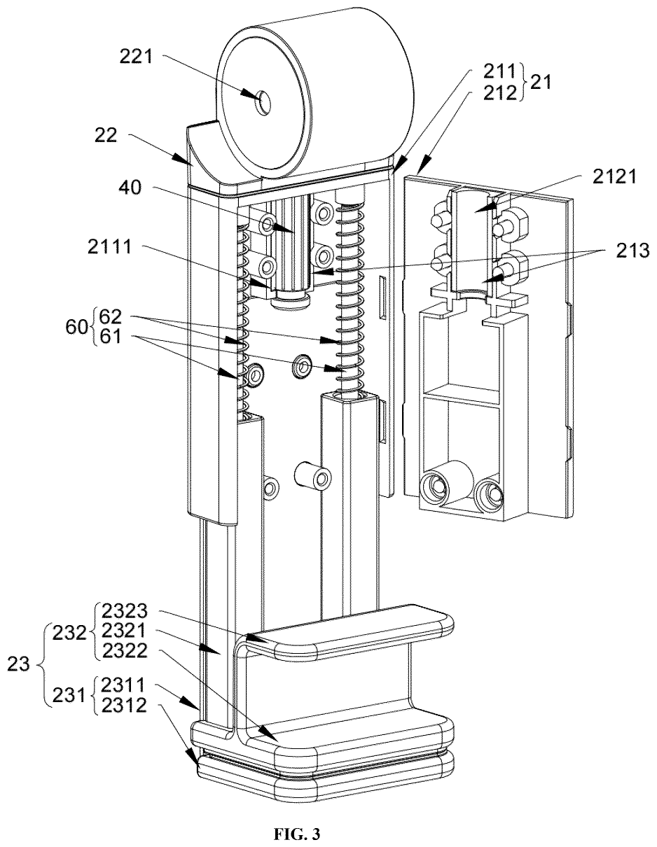

As shown in FIGS. 2-3, the first rotating shaft 30 is a damping shaft. Both ends of the damping shaft are fixedly connected to the support module 10, and the middle part of the damping shaft is rotatably connected to the rotating part 22.

In other embodiments, one of the support module 10 and the rotating part 22 is fixedly connected to one end of the first rotating shaft 30, and the other of the support module 10 and the rotating part 22 is movably connected to the other end of the first rotating shaft 30. As shown in FIG. 2, the second rotating shaft 40 is a rotating rod, which is arranged at the bottom of the rotating part 22. The fixation part 21 comprises a main body 211 and a front cover 212. The front cover 212 is detachably connected to the main body 211. The front cover 212 can not only shield the components in the main body 211, but also facilitate the maintenance and replacement of the components inside the main body 211. One end of the main body 211 close to the rotating part 22 is provided with a first shaft groove 2111, and one end of the front cover 212 close to the rotating part 22 is provided with a second shaft groove 2121. When the main body 211 and the front cover 212 are assembled into one unit, the first shaft groove 2111 and the second shaft groove 2121 are used to accommodate the shaft hole of the second rotating shaft 40, and the shaft hole is provided with a damping sleeve 213 for the rotational assembly of the second rotating shaft 40. The damping sleeve 213 is provided to generate friction force when the second rotating shaft 40 rotates, so that the second rotating shaft 40 can maintain the required angle of rotation without slipping.

The above embodiments are merely intended to illustrate the technical solution of the present disclosure, but not to limit the same. Any modifications or equivalent substitutions made by those skilled in the art to the technical solution of the present disclosure without departing from the spirit and scope of the present disclosure shall fall within the scope of the claims of the present disclosure.

What is claimed is:

1. A magnetic electronic device stand used for fixedly connecting an electronic device with a clamped object comprises: a support module, an adsorption part, the adsorption part is provided on the support module, and the adsorption part is provided for adsorbing the electronic device; and a fixation module, the fixation module comprises a fixation part, a rotating part and a clamping part; one end of the rotating part is hinged to one end of the support module through a first rotating shaft, and a second rotating shaft is provided at the other end of the rotating part; the second rotating shaft extends towards the fixation part, and the rotating part is hinged to one end of the fixation part through the second rotating shaft; the clamping part is provided for assembling the magnetic electronic device stand on the clamped object; when the center line of the second rotating shaft is projected onto the plane where the center line of the first rotating shaft is located, the projection of the center line of the second rotating shaft is perpendicular to the center line of the first rotating shaft; a fixation component is arranged between the adsorption part and the support module, and the adsorption part is fixedly assembled on the support module through the fixation component.

2. The magnetic electronic device stand according to claim 1, wherein the fixation component comprises an embedding unit and a matching unit; the embedding unit is arranged on the adsorption part, the matching unit is arranged on the support module, and the embedding unit is provided for inserting into the matching unit to assemble the adsorption part on the support module.

3. The magnetic electronic device stand according to claim 2, wherein the embedding unit comprises: an embedding frame, which is arranged on the adsorption part and on the surface of the adsorption part close to the support module; a screw, the head part of the screw is arranged within the range of the embedding frame, and the rod part of the screw extends towards the support module; and a positioning plate, which is arranged on the outer edge of the embedding frame; the matching unit comprises: an embedded slot, which is arranged on the surface of the support module close to the adsorption part, and the embedded slot is provided for the embedding frame to embed, so as to assemble the adsorption part;
a screw hole, which is arranged in the embedded slot, and the screw hole is provided for the screw to insert; and
a positioning slot, which is arranged on the outer edge of the embedded slot; when the embedding frame is embedded in the embedded slot, the positioning plate is inserted into the positioning slot.

4. The magnetic electronic device stand according to claim 3, wherein the positioning slot is communicated with the embedded slot, and the positioning plate is connected with the embedding frame.

5. The magnetic electronic device stand according to claim 3, wherein the positioning slot is arranged at an interval from the embedded slot, and the positioning plate is arranged at an interval from the embedding frame.

6. The magnetic electronic device stand according to claim 1, wherein a magnetic block is arranged on the adsorption part, or a suction cup is arranged on the adsorption part.

7. The magnetic electronic device stand according to claim 1, wherein it further comprises a reset unit, and the reset unit is connected with the fixation part;
the clamping part comprise:
a first limiting unit, which is arranged at one end of the fixation part away from the first rotating shaft and extends in the direction away from the first rotating shaft; and
a second limiting unit, which is movably connected with the reset unit, so that the second limiting unit is slidably connected with the fixation part and is located at one end of the fixation part away from the first rotating shaft; at least a part of the second limiting unit can move closer to or away from at least a part of the first limiting unit to form a clamping space; with the movement of the second limiting unit, the size of the clamping space can be adjusted;
wherein, the reset unit is provided for pushing the second limiting unit towards the first limiting unit, so that the second limiting unit can move near to the first limiting unit.

8. The magnetic electronic device stand according to claim 7, wherein the first limiting unit comprises:
a first connecting part, which is arranged at one end of the fixation part away from the first rotating shaft and extends in the direction away from the first rotating shaft; and
a first limiting part, which is arranged on the first connecting part and away from the fixation part, and the first limiting part is perpendicular to the first connecting part;
the second limiting unit comprises:
a second connecting part, one end of which is connected with the reset unit; and
a second limiting part, which is arranged at one end of the second connecting part away from the fixation part, and the second limiting part is perpendicular to the second connecting part; the second limiting part can movably move away from or move near to the first limiting part; when the second limiting part moves away from the first limiting part, an interval between the second limiting part and the first limiting part forms the clamping space.

9. The magnetic electronic device stand according to claim 8, wherein the reset unit comprises:
a third connecting part, one end of which is fixedly connected with the fixation part, and the other end of which is movably connected with the second connecting part;
a reset part, which is clamped between the second connecting part and the fixation part.

10. The magnetic electronic device stand according to claim 8, wherein a hand-operated part is arranged on the second limiting part, and the hand-operated part is provided for a user to pull the second limiting part to move away from the first limiting part.

11. The magnetic electronic device stand according to claim 10, wherein the hand-operated part is a L-shaped plate, and one end of the hand-operated part is fixedly connected with the second limiting part.
